(19) United States
(12) Patent Application Publication
(10) Pub. No.: US 2015/0239102 A1
(43) Pub. Date: Aug. 27, 2015

(54) Locking Pliers

(71) Applicant: Ming Chieh Wu, Taichung City (TW)

(72) Inventor: Ming Chieh Wu, Taichung City (TW)

(21) Appl. No.: 14/697,703

(22) Filed: Apr. 28, 2015

Related U.S. Application Data
(63) Continuation-in-part of application No. 14/485,884, filed on Sep. 15, 2014.
Application No. 14/485,884 is a continuation-in-part of application No. 13/469,469, filed on May 11, 2012, now Pat. No. 8,950,299.

(30) Foreign Application Priority Data
Jul. 12, 2011 (TW) 100124592

(51) Int. Cl. B25B 7/14; B25B 7/02

(52) U.S. Cl. CPC B25B 7/14; B25B 7/02

(57) ABSTRACT

A pair of locking pliers includes a fixed jaw including a first clamping surface which has a first edge and a second edge extending rearward of and tilting with respect to the first edge. A plurality of first teeth is asymmetrical and extends from the first edge of the first clamping surface. A movable jaw cooperates with the fixed jaw and includes a second clamping surface which has a first edge and a second edge extending rearward of and tilting with respect to the first edge. a plurality second teeth is asymmetrical and extends from the second edge of the second clamping surface. The pair of locking pliers in a tightening position thereof can grip a work piece firmly with the plurality of first teeth and the plurality of first teeth.

### CROSS REFERENCE TO RELATED APPLICATION

The present application is a continuation-in-part application of U.S. patent application Ser. No. 14/485,884 filed on Sep. 15, 2014, of which the disclosure is incorporated herein.

### BACKGROUND OF THE INVENTION

1. Field of the Invention

This invention relates to a pair of locking pliers and, more particularly to a pair of locking pliers that resists slipping on a work piece.

2. Description of the Related Art

Referring to FIG. 1, a pair of locking pliers 10 disclosed in U.S. Pat. No. 7,861,622 B2 includes a fixed handle 11 supporting a fixed jaw 12, a movable jaw 14 pivotally connected to the fixed handle 11 by means of a first pivot pin 13, a movable handle 16 pivotally connected to the movable jaw 14 by means of a second pivot pin 15, and a toggle-link locking mechanism 17 configured to lock the movable jaw in a closed, locked position. The fixed handle 11 has an oval slotted aperture 111. The first pivot pin 13 is movable in the aperture 111. A long axis of the aperture 111 is at an angle α with respect to a line extending through the center of the closed jaws 12 and 14. The angle α is approximately 15 degrees. The locking mechanism 17 has a link 173 pivotally connected to the movable handle 16 and is in sliding and pivoting contact with an adjustment screw 171. The locking mechanism 17 has a biasing member 172 extending between the movable jaw 14 and the fixed handle 11 to bias the jaws 12 and 14 away from each other.

Referring to FIGS. 2 and 3, the pair of pliers is used to grip a work piece 20. When a turning force applies to the pliers, the movable jaw 14 rotates clockwise around the second pivot pin 15 toward the fixed jaw 12 and the first pivot pin 13 in the aperture 111 moves rearward. Furthermore, the movable jaw 14 moves rearward and toward the fixed jaw 12, as indicated by arrows 21 and 22, to increase the gripping force on the work piece 20. Furthermore, the first pivot pin 13 moves to a rear end of the aperture 111 when the jaws 12 and 14 are operated to the closed, locked position. In this regard, the design of the aperture 111 is critical.

It is noted that a sliding engagement of the first pivot pin 13 with a wall defining the aperture 111 may be unstable. Therefore, the gripping force on the workpiece 20 is adversely affected and the pliers can not resist slipping on the work piece 20. Moreover, the aperture 111 has to be made precisely because the first pivot pin 13 can not move rearward in the aperture 111 if the axis of the aperture 111 suffers deviations from the angle α.

### SUMMARY OF THE INVENTION

An object of the present invention is to provide a pair of locking pliers that resists slipping on a work piece.

According to this invention, the pair of locking pliers includes a fixed handle. A fixed jaw fixedly is connected to the fixed handle and includes a first clamping surface. The first clamping surface has a first edge and a second edge extending rearward of and tilting with respect to the first edge. A plurality of first teeth is asymmetrical-extends from the first edge of the first clamping surface. A movable jaw cooperates with the fixed jaw and includes first and second joining ends and a second clamping surface. The second clamping surface has a first edge and a second edge extending rearward of and tilting with respect to the first edge. A plurality second teeth is asymmetrical and extends from the second edge of the second clamping surface. A movable handle is pivotally connected to the second joining end of the movable jaw about a first pivotal axis. A movable pivot unit includes a pivot pin engaging with the fixed handle and the first joining end of the movable jaw about a second pivotal axis. A biasing member engages with the fixed handle and the movable jaw such that the fixed handle and the movable jaw are subject to a tensional force of the biasing member. A lock unit engages with the fixed and movable handle to guard the movable jaw against displacement by counteracting a biasing action of the biasing member.

Upon changing the pair of locking pliers from initial, locking, to tightening positions thereof, the movable jaw is pivoted toward closer to the fixed jaw. Furthermore, the pair of locking pliers in the tightening position thereof includes the first edge of the first clamping surface and the second edge of the second clamping surface disposed substantially parallel to each other.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a partially sectioned side view of a conventional locking pliers disclosed in U.S. Pat. No. 7,861,622 B2 in a closed and locked position;

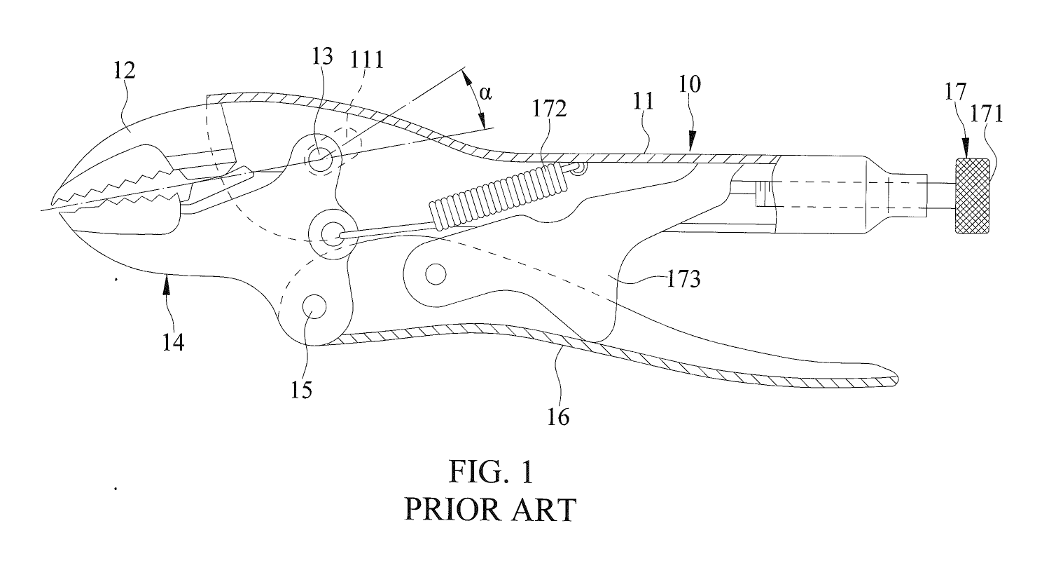

FIG. 2 is a partially sectioned side view of the conventional locking pliers in its closed, locked position on a work piece;

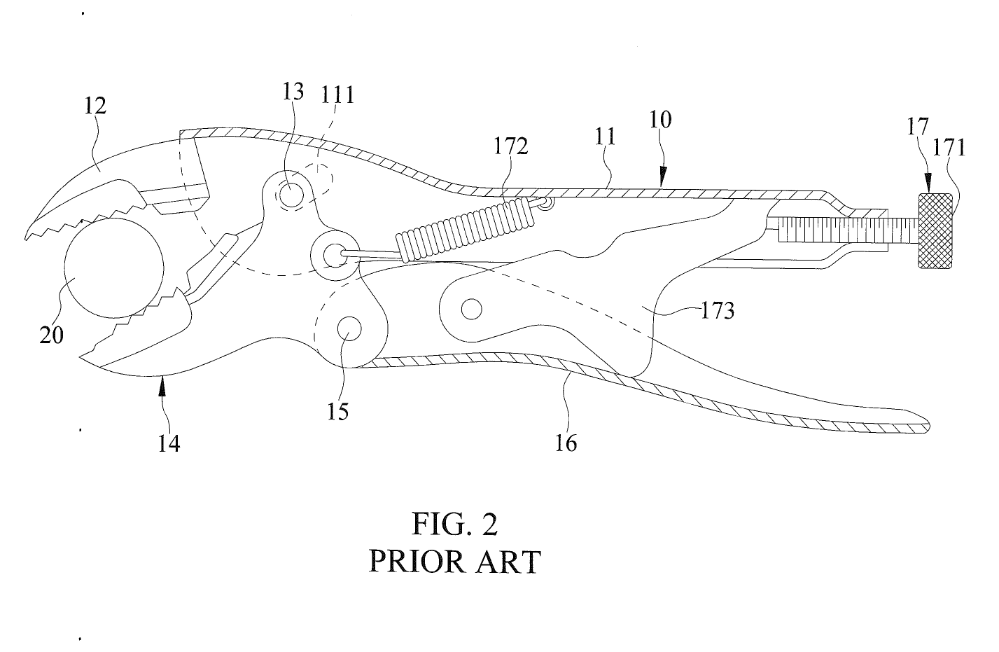

FIG. 3 is a partially sectioned side view of the conventional locking pliers in its closed, locked position on a work piece subject to a turning force, which causes a jaw and a pivot pin each to move to a position different from that shown in FIG. 2.

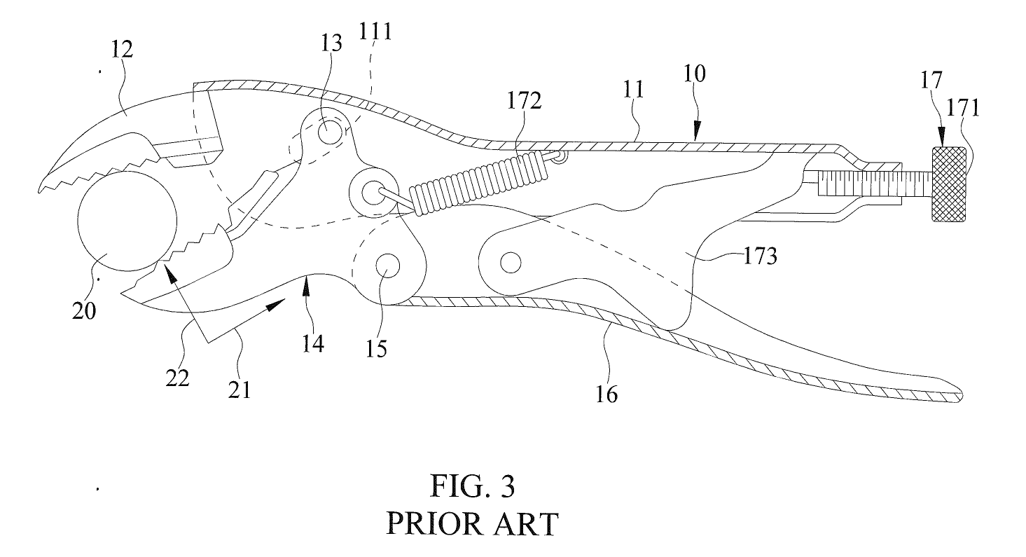

FIG. 4 is a perspective view of the a pair of locking pliers according to this invention;

FIG. 5 is an exploded perspective view of the pair of locking pliers according to this invention;

FIG. 6 is a partially sectioned side view of the pair of locking pliers of the present invention in an open state;

FIG. 7 is a partially sectioned side view of the pair of locking pliers of the present invention in an initially state;

FIG. 8 is a partially sectioned enlarged side view of a front end of the pair of locking pliers shown in FIG. 7.

FIG. 9 is a partially sectioned enlarged side view of the pair of locking pliers of the present invention in a locking state;

FIG. 10 is a partially sectioned enlarged side view of the pair of locking pliers of the present invention in a tightening state;

FIG. 11 is a partially sectioned enlarged side view of jaws of the pair of locking pliers shown in FIG. 10.

FIG. 12 is a partially sectioned enlarged side view of the pair of locking pliers of the present invention in an initial state on a work piece;

FIG. 13 is a partially sectioned enlarged side view of the pair of locking pliers of the present invention in a locking state on the workpiece;

FIG. 14 is a partially sectioned enlarged side view of the pair of locking pliers of the present invention in a tightening state on the work piece.

### DETAILED DESCRIPTION OF THE INVENTION

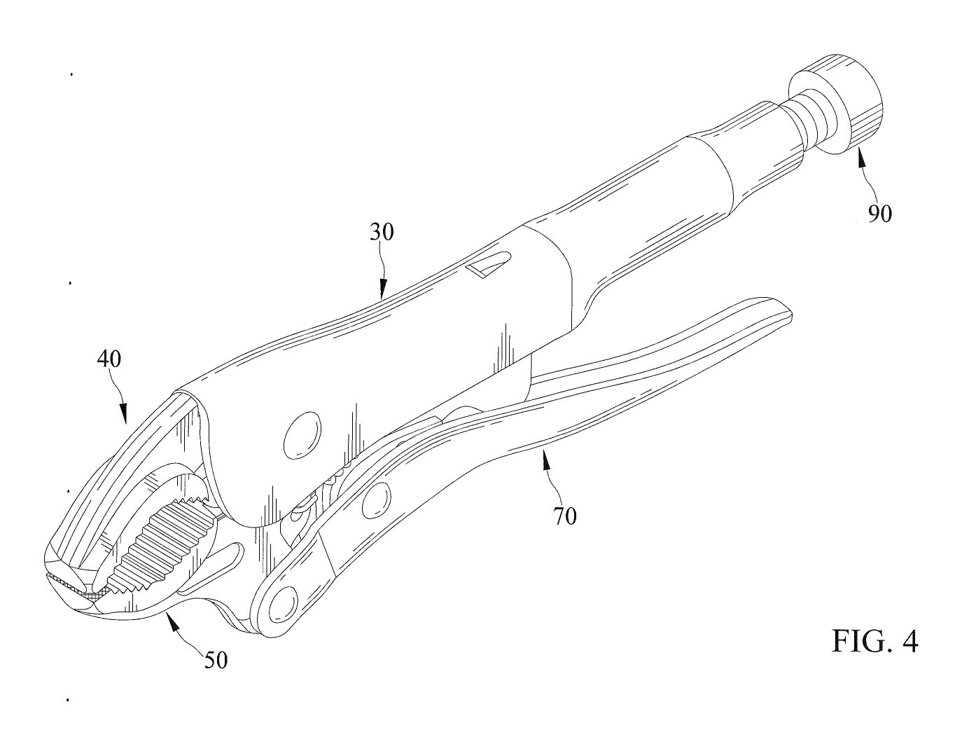

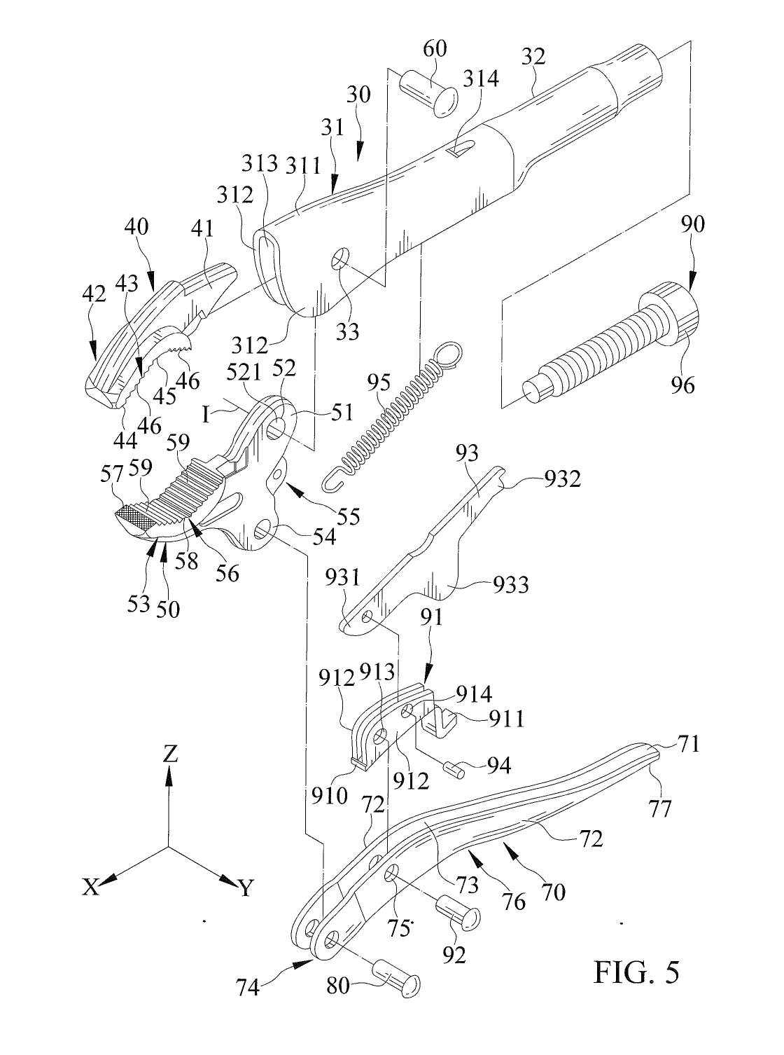

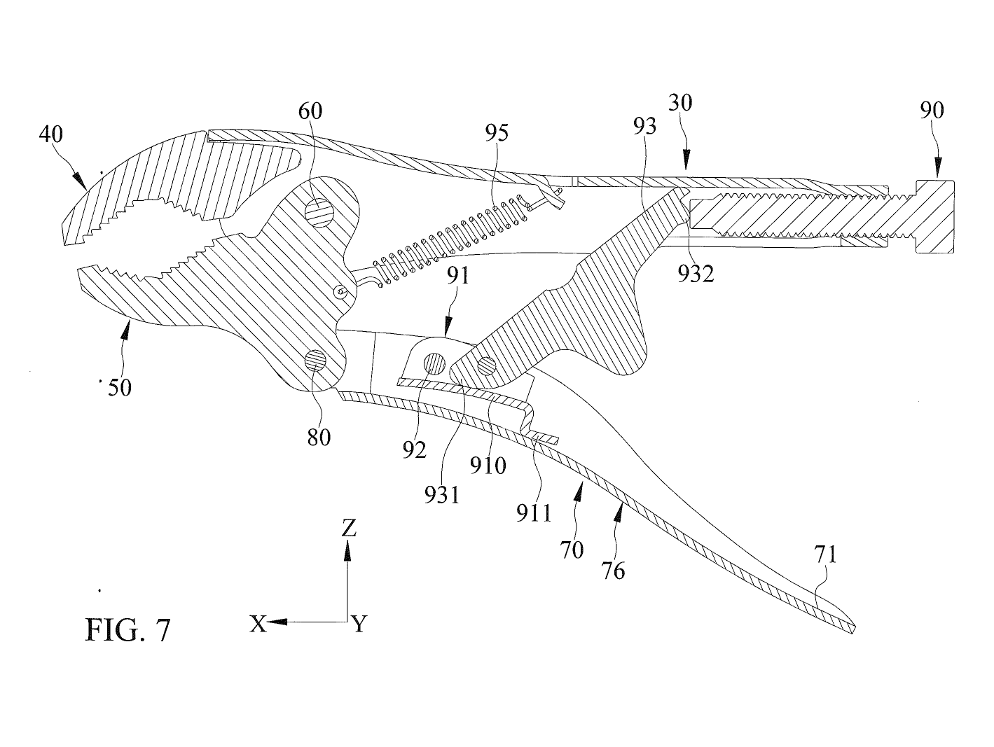

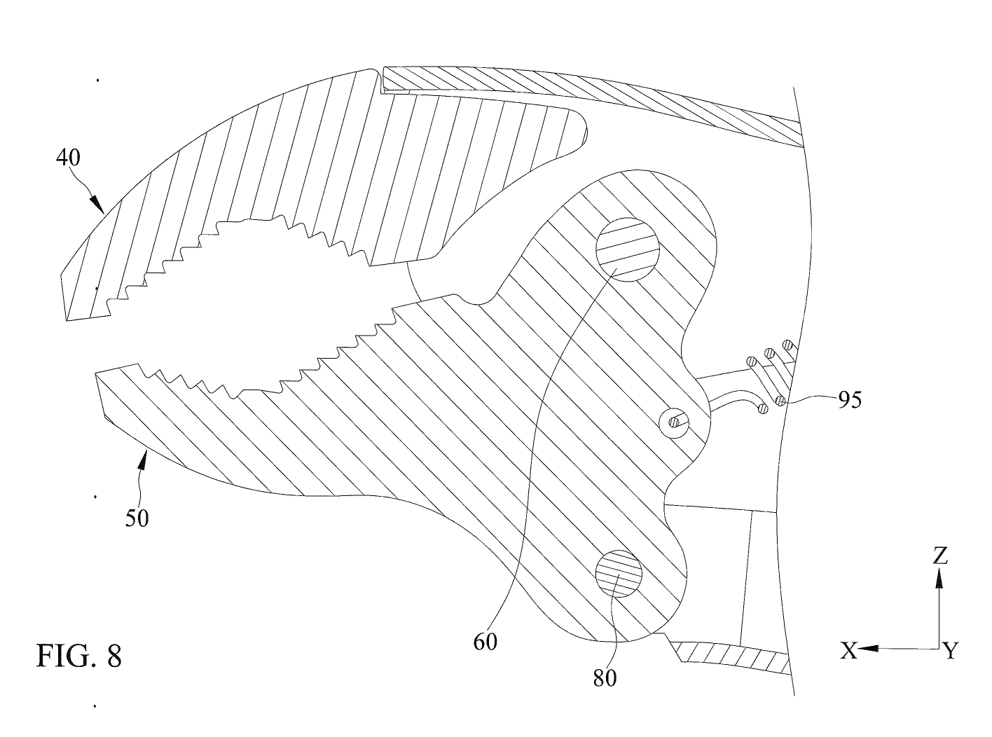

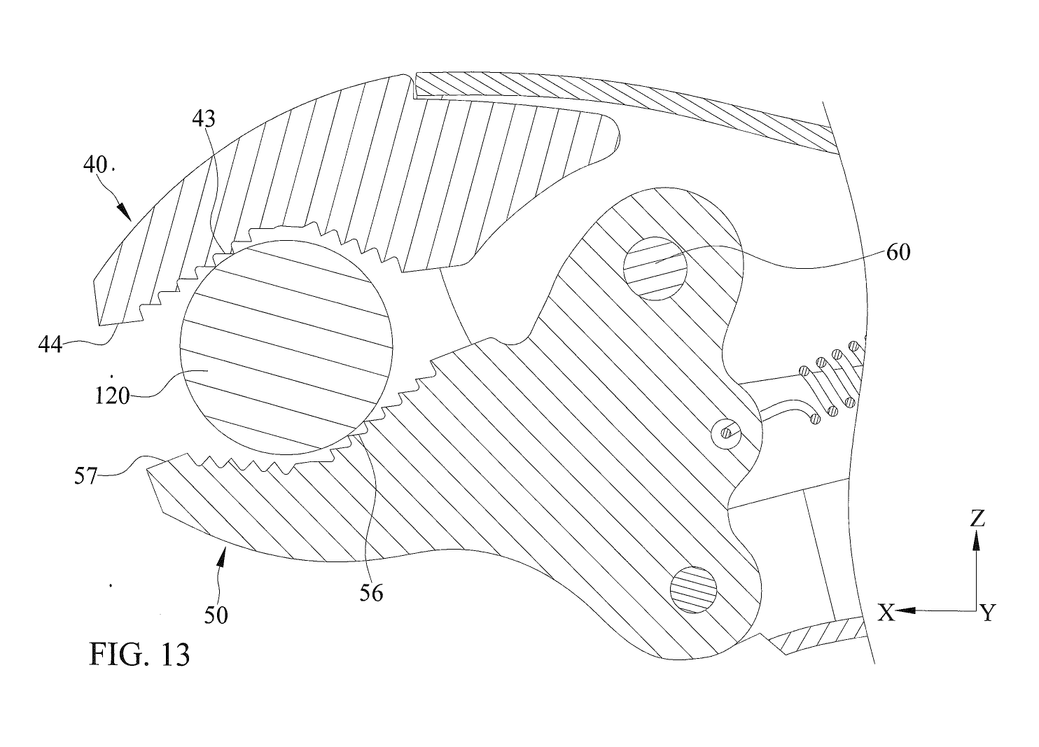

Referring to FIGS. 4 through 14, a pair of locking pliers according to the present invention is shown to include a fixed handle 30, a fixed jaw 40, a movable jaw 50, a movable handle 70, a movable pivot unit, a biasing member 95, and a lock unit 90.

The fixed handle 30 has front and rear handle portions 31 and 32 opposite to each other in a longitudinal direction X. A pivot hole 33 is formed on the front handle portion 31. A screw hole 34 is formed on the front the rear handle portion 32. In this embodiment, the front handle portion 31 is in the form of a grooved plate which includes an upper plate 311 and a pair of side plates 312. The pair of side plates 312 extends from the upper plate 311 in a transverse direction Z, which is transverse to the longitudinal direction X, to cooperatively define a recess 313. The pivot and screw holes 33 and 34 are communicated with the recess 313. A tab 314 extends from the upper plate 311 and into the recess 313.

The fixed jaw 40 has a first connected portion 41 which is connected securely to the front handle portion 31. The fixed jaw 40 has a first working portion 42 which extends forward in the longitudinal direction X from the first connected portion 41 and terminates at a first nose end 44. The first nose end 44 has a flat surface. The first working portion 42 has a first clamping surface 43 disposed immediately rearward in the longitudinal direction X from the first nose end 44. The first clamping surface 43 faces in the transverse direction Z. The first clamping surface 43 is formed with gripping teeth 46 extending from the first nose end 44 along a concaved contour 45. The gripping teeth 46 include a plurality of first teeth 461 and a plurality of second teeth 462. The plurality of first teeth 461 extends from a first edge of the first clamping surface 43. The plurality of second teeth 462 extends from a second edge of the first clamping surface 43. The first and second edges of the first clamping surface 43 are flat. The first edge of the first clamping surface 43 extends rearward from the first nose end 44 toward the second edge of the first clamping surface 43. The second edge of the first clamping surface 43 extends rearward of the first edge and a transition edge of the first clamping surface 43. The transition edge of the first clamping surface 43 interconnects distal ends of the first and second edges of the first clamping surface 43. The first and second edges of the first clamping surface 43 are tilted with respect to each other. The plurality of first teeth 461 and the plurality of second teeth 462 are different in shape. Each of the plurality of first teeth 461 has an asymmetric profile in that one of two profiled sides thereof, first-profiled side, is longer than the other, second profiled side, in length. The first and second profiled sides of each of the plurality of first teeth 461 respectively has first and second lengths measured from the first edge of the first clamping surface 43 to an apex of each of the plurality of first teeth 461. Therefore, the first length is longer than the second length. The first and second profiled sides of each of the plurality of first teeth 461 are tilted with respect to each other and extend divergently to the apex of each of the plurality of first teeth 461. The apex of each of the plurality of first teeth 461 is acute. The apexes of the plurality of first teeth 461 are aligned axially. The first profiled side of each of the plurality of first teeth 461 extends on an axis A1. The second profiled side of each of the plurality of first teeth 462 extends on an axis A2. An included angle between axes A1 and A2 is greater than 60 degrees. Each of the plurality of second teeth 462 has a symmetric profile in that two profiled sides thereof are the same in length. First and second profiled sides of each of the plurality of second teeth 462 respectively has first and second lengths measured from the second edge of the first clamping surface 43 to an apex of each of the plurality of second teeth 462. Therefore, the first and second lengths are equal. The first and second profiled sides of each of the plurality of second teeth 462 are tilted with respect to each other and extend divergently to the apex of each of the plurality of second teeth 462. The apex of each of the plurality of second teeth 462 is acute. The apexes of the plurality of second teeth 462 are aligned axially.

The movable jaw 50 has a second connected portion 55 which extends in the transverse direction Z. The second connected portion 55 terminates and defines first and second joining ends 51 and 54. The movable jaw 50 has a second working portion 53 which extends forward in the longitudinal direction X from the second connected portion 55 and terminates at a second nose end 57. The second nose end 57 is a flat surface which can abut the first nose end 44, as described later. The second working portion 53 has a second clamping surface 56 disposed immediately rearward in the longitudinal direction X from the second nose end 57. The second clamping surface 56 confronts the first clamping surface 43. The second clamping surface 56 is formed with gripping teeth 59. The gripping teeth 59 extend rearward of the second nose end 57 and along a concaved contour 58. The gripping teeth 59 include a plurality of first teeth 591 and a plurality of second teeth 592. The plurality of first teeth 591 extends from a first edge of the second clamping surface 56. The plurality of second teeth 592 extends from a second edge of the second clamping surface 56. The first edge of the first clamping surface 43 is disposed more adjacent to a front distal end of the pair of locking pliers than the second edge of the second clamping surface 56. The first and second edges of the second clamping surface 56 are flat. The first edge of the second clamping surface 56 extends rearward from the second nose end 57 toward the second edge of the second clamping surface 56. The second edge of the second clamping surface 56 extends rearward of the first edge and a transition edge of the second clamping surface 56. The transition edge of the second clamping surface 56 interconnects distal ends of the first and second edges of the second clamping surface 56. The first and second edges of the second clamping surface 56 are tilted with respect to each other. The plurality of first teeth 591 and the plurality of second teeth 592 are different in shape. Each of the plurality of first teeth 591 has a symmetric profile in that two profiled sides thereof are the same in length. First and second profiled sides of each of the plurality of first teeth 591 respectively has first and second lengths measured from the first edge of the second clamping surface 56 to an apex of each of the plurality of first teeth 462. Therefore, the first and second lengths are equal. The first and second profiled sides of each of the plurality of first teeth 591 are tilted with respect to each other and extend divergently to the apex of each of the plurality of first teeth 591. The apex of each of the plurality of first teeth 591 is acute. The apexes of the plurality of first teeth 591 are aligned axially. Each of the plurality of second teeth 592 has an asymmetric profile in that one of two profiled sides thereof, first profiled side, is longer than the other in length, second profiled side. The first and second profiled sides of each of the plurality of second teeth 592 respectively has first and second lengths measured from the second edge of the second clamping surface 56 to an apex of each of the plurality of second teeth 592. Therefore, the first length is longer than the second length. The first and second profiled sides of each of the plurality of second teeth 592 are tilted with respect to each other and extend divergently to the apex of each of the plurality of second teeth 592. The apex of each of the plurality of second teeth 592 is acute. The apexes of the plurality of second teeth 592 are aligned axially. The first profiled side of each of the plurality of first teeth 461 extends on an axis B1. The second profiled side of each of the plurality of second teeth 462 extends on an axis B2. An included angle between axes B1 and B2 is greater than 60 degrees.

The movable handle 70 has a front pivot portion 74 pivotally connected to the second joining end 54 by means of a pivotal pin 80 about a pivotal axis, which has a fixed position and is in an axial direction Y transverse to the longitudinal and transverse directions X and Z. The movable handle 70 has a rear actuating portion 76 which extends rearward from the front pivot portion 74 in the longitudinal direction X and terminates at a movable handle end 77. The movable handle end is manually operable when operating the pair of locking pliers. In this embodiment, the movable handle 70 is in the form of a grooved plate which includes a base seat 71 and a pair of wings 72. The pair of wings 72 extends from the base seat 71 in the transverse direction Z and is spaced apart from each other in the axial direction Y. The base seat 71 and the pair of wings 72 cooperatively define a concavity 73.

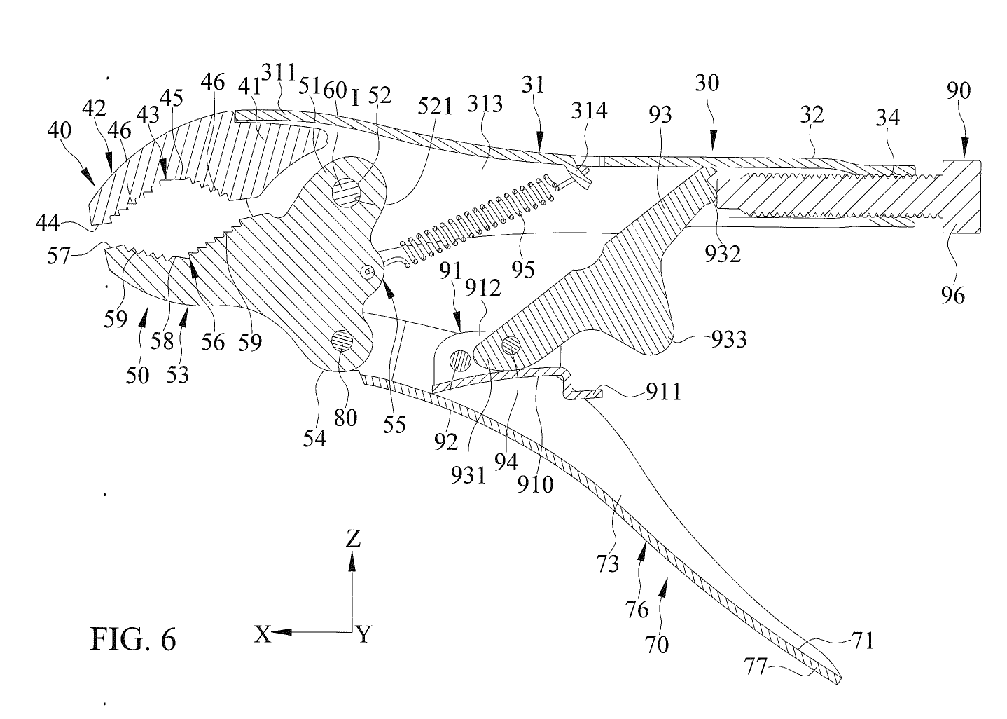

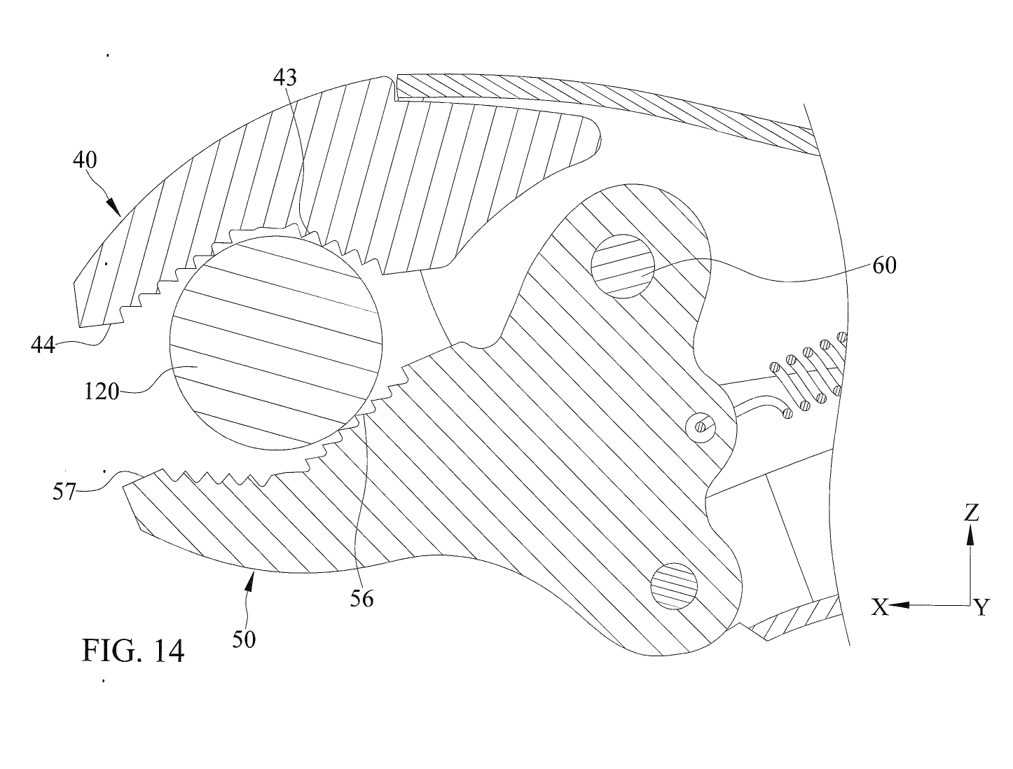

Referring to FIGS. 6 and 14, a movable pivot unit includes a pivot pin 60 and a pivot hole 52. The pivot pin 60 is disposed on the front handle portion 31 through the pivot hole 33. The pivot pin 60 extends along a pivot axis parallel to the pivotal axis of the pivotal pin 80. The pivot pin 60 has a circular contour. The pivot hole 52 is disposed in the first joining end 51 of the movable jaw 50. Alternatively, the pivot pin 60 is disposed on the first joining end 51 of the movable jaw 50 and the pivot hole 52 is disposed in the front handle portion 31. The pivot hole 52 has an inner periphery defining an inner tubular surface 521. The inner tubular surface 521 has a circular contour. The inner tubular surface 521 and the pivot pin 60 have similar contour. A central axis I extends through a center of the pivot hole 52. The second clamping surface 56 is close, closer and closest to the first clamping surface 43 respectively upon changing locking pliers among initial, locking, and tightening positions thereof, as will be described hereinafter.

The biasing member 95 has one end connected to the tab 314 and another end connected to the second connected portion 55 respectively to bias the movable jaw 50. Therefore, the fixed handle 30 and the movable jaw 50 are subject to a tensional force of the biasing member 95. The biasing member 95 is released from tension when the pair of locking pliers is in the initial position thereof. In this embodiment, the biasing member 95 is a tension spring.

The lock unit 90 is a toggle locking assembly which includes a linkage interconnecting the fixed and movable handles 30 and 70. The linkage includes a first linkage 91 and a second linkage 93. The first linkage 91 is disposed in the concavity 73. The first linkage 91 has a first proximate end 913 and a first distal end 914. The first proximal end 913 is pivotally connected to the rear actuating portion 76 of the movable handle 70 by a first linking pin 92 about a first linking axis. The first linkage 91 is a grooved plate including a lever wall 910 extending rearward in the longitudinal direction X and terminating at a power end 911, and a pair of side walls 912 extending in the transverse direction Z from the lever wall 910. The second linkage 93 has a second proximate end 931 pivotally connected to the first distal end 914 by a second linking pin 94 about a second linking axis. The second linkage 93 has a second distal end 932 disposed in the recess 313 and slidably engaged with and retained in the rear handle portion 32. The second distal end 932 of the second linkage 93 is in contact with an adjustment screw 96. The adjustment screw 96 is threadedly engaged with the screw hole 34. The second linkage 93 has a protrusion 933 extending rearward to serve as a stop. The adjustment screw 96 can be operated to adjust a separating distance between the fixed and movable jaws 40 and 50.

In this embodiment, each of the pivot pin 60, the pivotal pin 80, and the first and second linking pins 92 and 94 is a rivet.

As shown in FIG. 6, when the pair of locking pliers is in the initial position thereof, the movable handle 70 is disposed away from the fixed handle 30 and the power end 911 of the first linkage 91 is turned by the second linkage 93 about the first linking axis to space apart from the base seat 71 in the transverse direction Z.

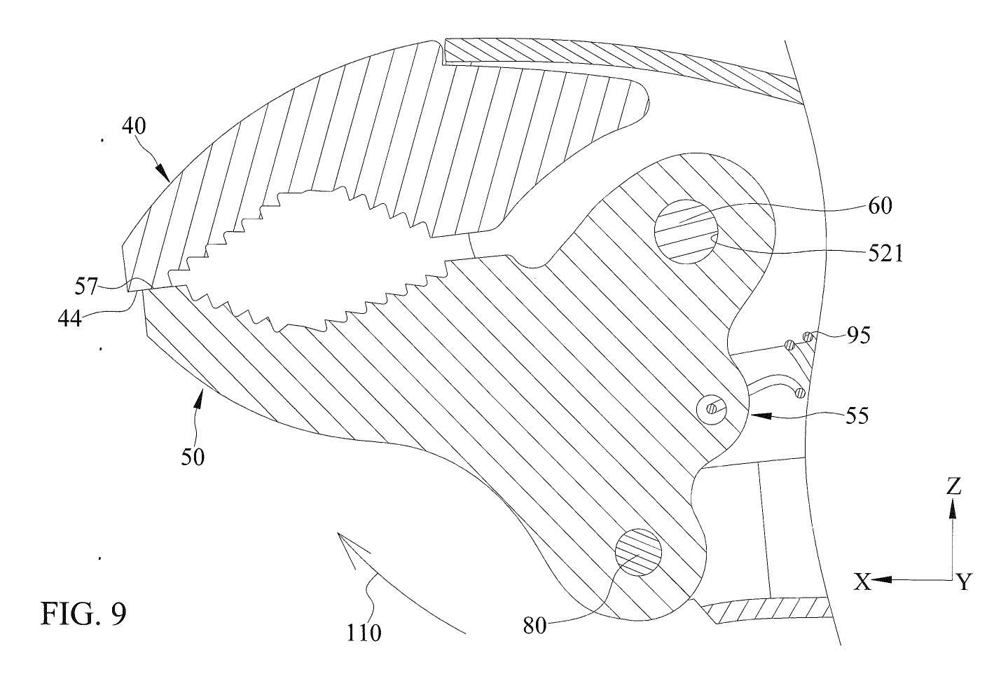

As shown in FIG. 9, when a manual turning force applies to move the movable handle 70 toward the fixed handle 30 to permit the power end 911 to contact with the base seat 71, the movable jaw 50 will be turned toward the fixed jaw 40, the second linkage 93 will be turned clockwise about the second linking axis of the second linking pin 94, and the movable jaw 50 will be turned clockwise as indicated by the arrow 110 about the pivotal axis of the pivotal pin 80 against the biasing action of the biasing member 95. As shown in FIG. 9, the pair of locking pliers in the locking position thereof includes the second nose end 57 abutting the first nose end 44. In addition, when the movable jaw 50 is displaced from a-position which the pair of locking pliers is in initial position thereof to another position which the pair of locking pliers is in the locking position thereof, the lever wall 910 will cause the second proximate end 931 to displace to a first over-center position in which the pivotal axis of the pivotal pin 80, the second linking axis of the second linking pin 94, and the second distal end 932 are in a near straight line with the first linking axis of the first linking pin 92, thereby holding the movable jaw 50 in a locking position thereof.

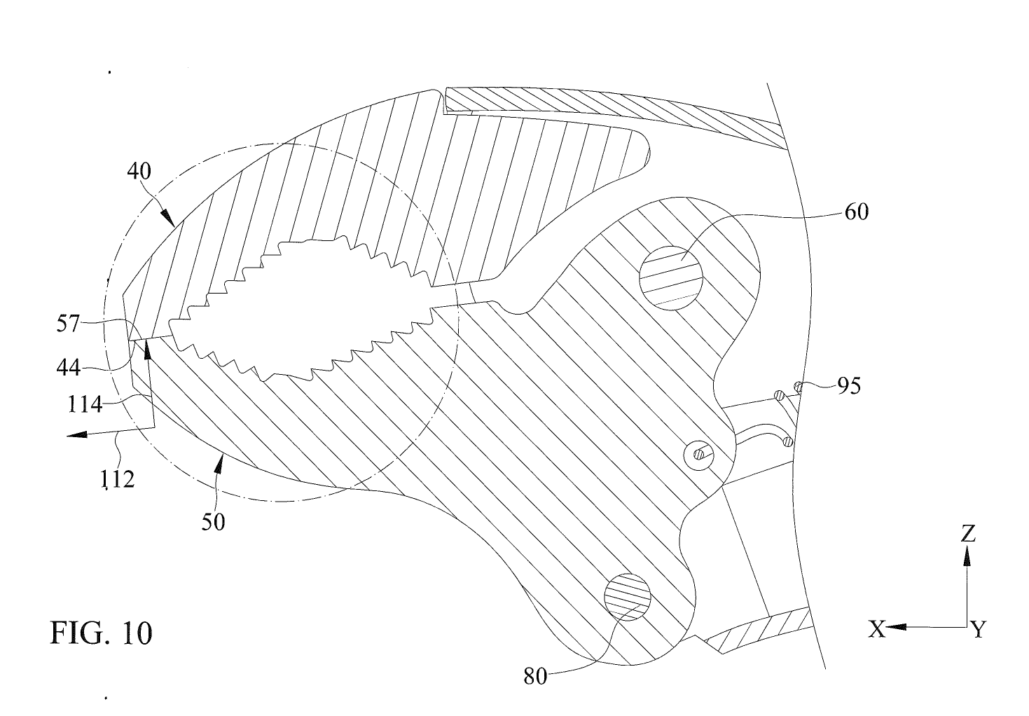

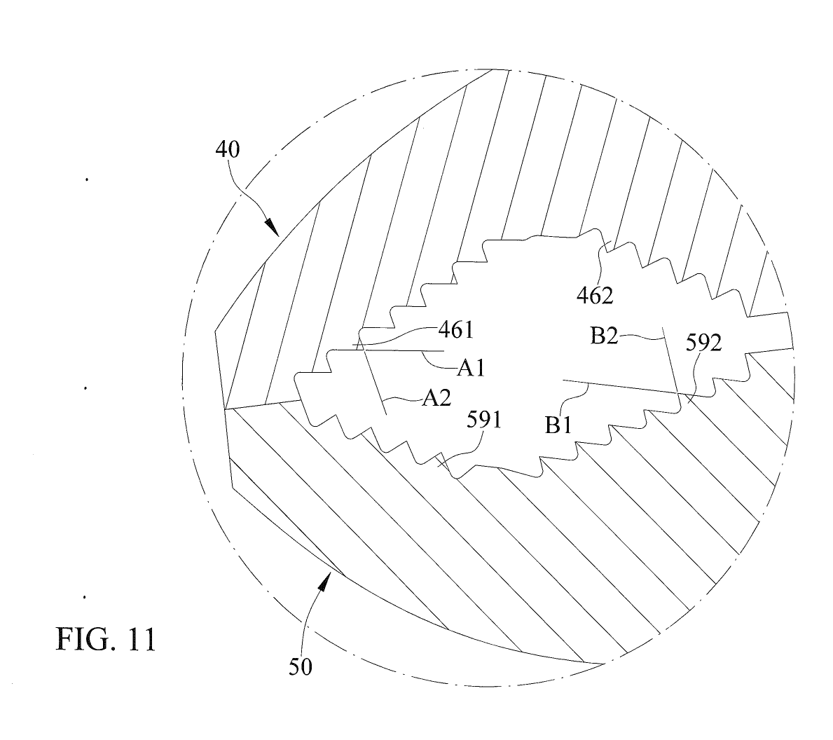

When the manual turning force applies to move the movable handle 70 toward the fixed handle 30 to permit the protrusion 933 to contact with the base seat 71, the movable jaw 50 will be forced to turn clockwise about the pivotal axis of the pivotal pin 80 and be subject to a force component in a direction 112 and another force component in a direction 114. The forces components bring the flat surfaces of the first and second nose ends 44 and 57 into fully abutment with each other. As shown in FIGS. 10 and 11, the pair of locking pliers in the tightening position thereof includes the first and second nose ends 44 and 57 abutting against one another. Furthermore, the first profiled sides of each of the plurality of first teeth 461 and each of the plurality of second teeth 592 are substantially parallel to each other when the pair of locking pliers is in the tightening position thereof. Furthermore, the second profiled sides of each of the plurality of first teeth 461 and each of the plurality of second teeth 592 are substantially parallel to each other when the pair of locking pliers is in the tightening position thereof. FIG. 11 also shows the first edge of the first clamping surface 43 being substantially parallel to the second edge of the second clamping surface 56. In addition, when the movable jaw 50 is displaced from the position which the pair of locking pliers is in the locking position thereof to a position which the pair of locking pliers is in the tightening position thereof, the second proximate end 931 will be caused by the wall lever 910 to turn about the second linking axis of the second linking pin 94 so as to be shifted to a second over-center position in which the pivotal axis of the pivotal pin 80, the second linking axis of the second linking pin 94, and the second distal end 932 are in a substantially straight line with the first linking axis of the first linking pin 92, thereby holding the movable jaw 50 in the tightening position thereof.

When it is desired to release the movable jaw 50 from the position which the pair of locking pliers is in the tightening position thereof, an opposite manual turning force will apply to the movable handle 70 to move it away from the rear handle portion 32. Then, the movable jaw 50 can go back to the position which the pair of locking pliers is in the initial position thereof by the biasing action of the biasing member 95.

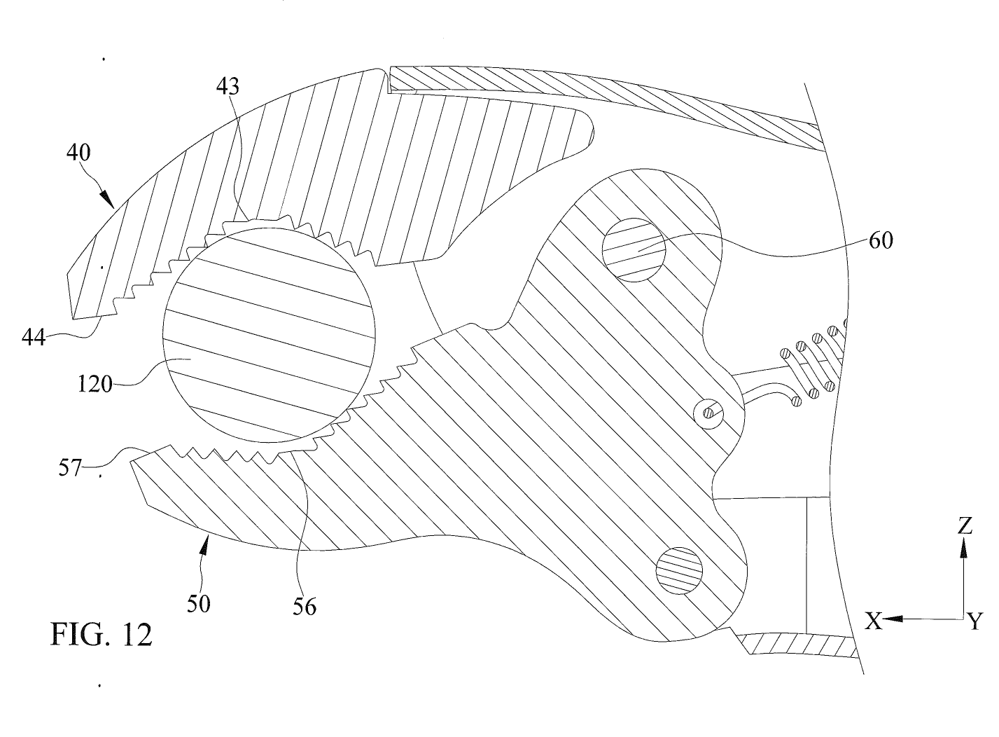

In use of the pair of locking pliers to grip a work piece 120, referring to FIGS. 12 to 14, the procedure includes operating the pair of locking pliers to the initial position thereof, so the movable jaw 50 is opened relative to the fixed jaw 40 and the work piece 120 can be placed therebetween. Subsequently, the movable handle 70 is turned toward the rear handle portion 32 to turn the movable jaw 50 toward the fixed jaw 40, thereby permitting the clamping surfaces 43 and 56 to lock on the workpiece 120. Finally, the manual turning force is continued to apply to the movable handle 70 until the pair of locking pliers is in the tightening position thereof. Therefore, the work piece 120 is tightly gripped by the gripping teeth 46 and 59, which is specially designed as set forth.

In view of the forgoing, the pair of locking pliers is with a design that is able to firm grip the work piece 120. The pair of locking pliers is in the tightening position thereof to firmly grip the work piece 120. Firmly means that the pair of locking pliers resists slipping on the work piece 120. Firmly means that the pair of locking pliers will not slip over the work piece 120 at higher applied torques. The gripping teeth 46 and 59 prevent the pair of locking pliers from slipping on the work piece 120.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A pair of locking pliers comprising:
a fixed handle;
a fixed jaw fixedly connected to the fixed handle and including a first clamping surface, with the first clamping surface having a first edge and a second edge extending rearward of and tilting with respect to the first edge, and with a plurality of first teeth being asymmetrical and extending from the first edge of the first clamping surface;
a movable jaw cooperating with the fixed jaw and including first and second joining ends and a second clamping surface, with the second clamping surface having a first edge and a second edge extending rearward of and tilting with respect to the first edge, and with a plurality second teeth being asymmetrical and extending from the second edge of the second clamping surface;
a movable handle pivotally connected to the second joining end of the movable jaw about a first pivotal axis;
a movable pivot unit including a pivot pin engaging with the fixed handle and the first joining end of the movable jaw about a second pivotal axis;
a biasing member engaging with the fixed handle and the movable jaw such that the fixed handle and the movable jaw are subject to a tensional force of the biasing member; and
a lock unit engaging with the fixed and movable handle to guard the movable jaw against displacement by counteracting a biasing action of the biasing member;
wherein upon changing the pair of locking pliers from initial, locking, to tightening positions thereof, the movable jaw is pivoted toward closer to the fixed jaw; and
wherein the pair of locking pliers in the tightening position thereof includes the first edge of the first clamping surface and the second edge of the second clamping surface are disposed substantially parallel to each other.

2. The pair of locking pliers as claimed in claim 1, wherein two asymmetrical profiled sides of each of the plurality of first teeth includes a longer profiled side and a shorter profiled side, wherein two asymmetrical profiled side of each of the plurality of second teeth includes a longer profiled side and a shorter profiled side, wherein the pair of locking pliers in the tightening position thereof includes the longer profiled sides of each of the plurality of first teeth and each of the plurality of second teeth substantially parallel to each other, and wherein the pair of locking pliers in the tightening position thereof includes the shorter profiled sides of each of the plurality of first teeth and each of the plurality of second teeth substantially parallel to each other.

3. The pair of locking pliers as claimed in claim 2, wherein each of the plurality of first teeth has an apex and includes the longer and shorter profiled sides thereof extending divergently toward the apex thereof, wherein the apex of each of the plurality of first teeth is acute, wherein the apexes of the plurality of first teeth are aligned axially, wherein each of the plurality of second teeth has an apex and includes the longer and shorter profiled sides thereof extending divergently toward the apex thereof, wherein the apex of each of the plurality of second teeth is acute, and wherein the apexes of the plurality of second teeth are aligned axially.

4. The pair of locking pliers as claimed in claim 1, wherein the lock unit includes a first linkage, a second linkage, and an adjustment screw, wherein the first linkage is pivotally connected to the movable handle about a first linking axis, wherein the first linkage includes a lower wall terminating in a power end which is spaced from the lower wall in a transverse direction, wherein the power end is releasably abutting with the movable handle spaced in a longitudinal direction from the first link axis, wherein the second linkage pivotally connected to the first linkage, and wherein the adjustment screw is threadably engaged with the fixed handle and abuts against the second linkage.

5. The pair of locking pliers as claimed in claim 4, wherein the first linkage includes a pair of side walls extending in the transverse direction from the lower wall, and wherein the second linkage is pivotally connected between the pair of side walls spaced from and parallel to the first link axis.

6. The pair of locking pliers as claimed in claim 4, wherein the movable handle has a structure including a base seat and a pair of wings extending from the base seat, wherein the base seat and the pair of wings cooperate to form a concavity, wherein the power end is not in contact with the base seat when the pair of locking pliers is in the initial position thereof, and wherein the power end is in contact with the base seat when the pair of locking pliers is in the tightening position thereof.

7. The pair of locking pliers as claimed in claim 6, wherein the second linkage includes a protrusion extending rearward therefrom, wherein the protrusion is not in contact with the base seat when the pair of locking pliers is in the initial position thereof, and wherein the protrusion is in contact with the base seat when the pair of locking pliers is in the tightening position thereof.

8. The pair of locking pliers as claimed in claim 1, wherein the first pivotal axis, the first linking axis and a distal end of the second linkage are in a substantially straight line with the first linking axis when the pair of locking pliers is in the tightening position thereof.

9. The pair of locking pliers as claimed in claim 1, wherein the fixed jaw includes a nose end disposed immediately forward to the first clamping surface, wherein the movable jaw includes a second nose end disposed immediately forward to the second clamping surface, wherein the first and second nose ends partially abut with each other in a when the pair of locking pliers is in the locking and tightening positions thereof.

10. The pair of locking pliers as claimed in claim 1, wherein the second edge of the first clamping surface includes a plurality of third teeth being symmetrical and extending therefrom, and wherein the first edge of the second clamping surface includes a plurality fourth teeth being symmetrical and extending therefrom.

11. The pair of locking pliers as claimed in claim 2, wherein the second edge of the first clamping surface includes a plurality of third teeth being symmetrical and extending therefrom, and wherein the first edge of the second clamping surface includes a plurality fourth teeth being symmetrical and extending therefrom.

12. The pair of locking pliers as claimed in claim 11, wherein each of the plurality of third teeth has an apex and includes two symmetrical profiled sides thereof extending divergently toward the apex thereof, wherein the apex of each of the plurality of third teeth is acute, wherein the apexes of the plurality of first teeth are aligned axially, wherein each of the plurality of fourth teeth has an apex and includes two symmetrical profiled sides profiled sides thereof extending divergently toward the apex thereof, wherein the apex of each of the plurality of fourth teeth is acute, and wherein the apexes of the plurality of fourth teeth are aligned axially.

13. The pair of locking pliers as claimed in claim 1, wherein the first edge of the first clamping surface is disposed more adjacent to a front distal end of the pair of locking pliers than the second edge of the second clamping surface.
